(19) United States
(12) Patent Application Publication
(10) Pub. No.: US 2025/0160559 A1
(43) Pub. Date: May 22, 2025

(54) Tabletop Cooker with Centrally Positionable Secondary Basket

(71) Applicant: James Warner Haskins, San Diego, CA (US)

(72) Inventor: James Warner Haskins, San Diego, CA (US)

(21) Appl. No.: 18/951,560

(22) Filed: Nov. 18, 2024

Related U.S. Application Data
(60) Provisional application No. 63/599,986, filed on Nov. 16, 2023.

(51) Int. Cl. A47J 27/13; A47J 36/06

(52) U.S. Cl. CPC A47J 27/13; A47J 36/06

(57) ABSTRACT

A tabletop cooker is provided which is configurable to a stacked positioning having a cooking basket with a secondary cooking area which may be located to a stacked configuration atop a cooker having a first cooking area therein to provide two areas for concurrently cooking two foodstuffs. The cooking basket may be placed in a position within the first cooking area when the cooker is configured to a stowed positioning for compact storage and a smaller container for shipping.

This application claims priority to U.S. Provisional Patent Application Ser. No. 63/599,986 filed on Nov. 16, 2023.

### FIELD OF THE INVENTION

The disclosed device relates to an improved counter top food cooking device. More particularly, it relates to such a counter top cooking device having a centrally positionable cooking basket, which is employable to substantially double the cooking area of the device.

### BACKGROUND OF THE INVENTION

Conventional rice cookers, which are functionally similar to slow cookers, have become ever more popular throughout the world. In the conventional electric slow cooker, or rice cooker, the cooker is turned on by the user using a switching means, such as a mechanical or push button switch. Thereafter, heating elements of the cooker are automatically activated only to cause the temperature of the cooking cavity in the pot to rise to a predetermined temperature, which is only sufficient for boiling the contents.

In a boiling sequence in conventional cookers, the mixture of rice and liquid or other contents within the cooking cavity rises in temperature only to a boiling point, using the heat from the heating element which is activated once the user switches the cooker to an “on” position. During the boiling sequence, the temperature of the cavity, conventionally, can rise suddenly, once all of the liquid in the cooking cavity is exhausted and boiled-off during cooking.

Such conventional cookers are available with a cooker unit or housing, which surrounds a single cooking area housed within the sidewall of the cooker unit and underneath a removable lid. This conventional cooker arrangement limits the amount of food that may be cooked to the volume of a single cooking area within the cooker unit.

The forgoing examples of related tabletop cooker and rice cooker art and limitations related therewith are intended to be illustrative and not exclusive, and they do not imply any limitations on the disclosed device and system described and claimed herein. Various additional limitations of the related art will become apparent to those skilled in the art upon reading and understanding the specification below and the accompanying drawings.

In this respect, before explaining at least one embodiment of the slow cooker or rice cooking apparatus herein in detail, it is to be understood that the expandable cooker invention is not limited in its application to the details of construction and to the arrangement of the components set forth in the following description or illustrated in the drawings, nor the steps outlined in the specification. The disclosed rice cooker with a positionable cooking basket is capable of other embodiments and of being practiced and carried out in various ways as those skilled in the art will readily ascertain, once educated in the novel device and method of operation disclosed in this application.

Also, it is to be understood that the phraseology and terminology employed herein are for the purpose of description and should not be regarded as limiting in any manner. As such, those skilled in the art will appreciate that the concept upon which this disclosure is based may readily be utilized as a basis for designing other methods and systems for carrying out the several purposes of the expandable cooker disclosed herein. It is important, therefore, that the claims be regarded as including such equivalent construction insofar as they do not depart from the spirit and scope of the present invention.

### OBJECTS OF THE INVENTION

An object of this invention is to provide a counter top electric cooking device, slow cooker, or rice cooker and the like, which includes a cooking basket which is positionable atop a mounting ring to form a secondary cooking area above a primary cooking area.

An additional object of this invention is to provide such a cooker wherein the cooking basket which is positionable to provide the secondary cooking area is positionable when not in use, entirely within the primary cooking area to thereby provide a smaller sized pot during storage in a cupboard and for shipping.

These, together with other objects and advantages of the disclosed counter top cooking device with a basket and secondary cooking area herein, which will become subsequently apparent to those skilled in the art, reside in the details of the construction and method herein as more fully hereinafter described and claimed. Reference being made to the accompanying drawings forming a part thereof, wherein like numerals refer to like parts throughout.

### SUMMARY OF THE INVENTION

The cooking device herein described and disclosed in all preferred modes includes a primary counter top style cooking pot or cooker, such as those conventionally used in a rice cooker or slow cooker. Within the confines of the sidewalls of the cooker is located a primary cooking area wherein food is positioned during the cooking process. A removable lid provides a releasable seal when positioned upon a ledge extending from the sidewall of the primary cooker where it surrounds a cooker opening.

While conventional cookers exist which can stack a basket atop the main cooking component, conventional stacked cooking components are not configured to allow a nesting or placement of the stackable basket within the interior cavity of the underlying cooking component. The stackable tabletop cooker herein is configured to allow a nesting or positioning of the stackable basket within the primary cooking area of the cooking pot for easy and compact storage and to maintain all of the components of the stackable cooker in one place. Additional utility is provided by the fact that the lid is configured to fit substantially within the confines of the primary cooking area also by flipping the position to an upside down placement. This utility of the nesting of the basket and the lowered positioning of the lid not only provides a compact device for kitchen storage, it significantly reduces the overall size for shipping and boxing. The device for sale thereby saving room on shelves and shipping vehicles, as well as saving packaging required.

Also included in the device herein is a user-positionable cooking basket. In a stored position, this cooking basket is entirely nested within the primary cooking area of the cooker. In this stored position, a lid may be operatively positioned upon the ledge extending from the upper end of the sidewall of the cooker.

At the option of the user, the cooking basket and the secondary cooking area provided thereby may be removed from any engagement with the cooker during use. This configuration allows for cooking food solely within the primary cooking area. Still further, at the option of the user, this cooking basket can be positioned with a bottom area thereof in a substantially sealed engagement within the distal end of the sidewall of the primary cooker. Such is accomplished by the provision of a user-positionable annular ring component.

This annular ring, during storage and transport of the device, with the cooking basket within the primary cooking area, is located atop an annular ledge extending around and defining an open end of the basket. The same annular ring is employed to hold the cooking basket in a mounted position with a lower end thereof protruding into the primary cooking area of the cooker. This is accomplished with an interior circumference of the annular ring, which defines a passage therethrough, being sized to engage a bottom surface of the cooking basket in a manner to support it elevated above the primary cooking area.

A circular projection, extending from the bottom surface of the cooking basket, is sized for engagement thereof within the central opening of the annular ring. The bottom surface of the annular ring is sized for positioning atop the sidewall of the cooker. A recess may be formed into this bottom surface which is configured to hold the annular ring securely centered atop the cooker sidewall.

As noted, the cooking device herein has a stored and shipment configuration wherein the entire cooking basket is located within the primary cooking area of the cooker. In this stored configuration the annular ring is located to a sandwiched engagement in-between the lid and a top surface of the basket.

The ring is repositionable to support the cooking basket and position the secondary cooking area above the primary cooking area. This configuration and positioning of the cooking basket substantially increases the volume of the available cooking area of the cooker. Additionally, this stacked configuration provides for two different cooking areas, such as the primary cooking area for rice, and the secondary cooking area can be for vegetables, bread, a side dish or other food which may be cooked therein.

A bottom surface of the cooking basket has a plurality of openings therein to provide for the passage of heat and moisture from the primary cooking area of the cooker into the secondary cooking area of the cooking basket. While shown herein as a plurality of circular holes, the openings can be in any configuration which is determined to provide the proper heat and moisture flow to the secondary cooking area for cooking. For example and in no way limiting, the bottom of the basket component can be adapted on a top surface thereof to hold eggs through the provision of a hole or opening therein adapted to the task of holding hard-boiling egg therein.

With respect to the above description then, it is to be realized that the dimensional relationships for the parts of the invention disclosed herein may also include variations in size, materials, shape, form, function and manner of operation, manner of formation, assembly and use, which are deemed readily apparent and obvious to one skilled in the art subsequent to their review of this specification. Therefore, the foregoing summary and following detailed description are considered as illustrative only of the principles of the invention to provide a slow cooker, rice cooker, or similar counter top cooker which has a user positionable basket which, when mounted, significantly increases the cooking area of the cooker.

Further, since numerous modifications and changes will readily occur to those skilled in the art, it is not desired to limit the invention to the exact construction and operation and steps of formation shown and described, and accordingly, all suitable modifications and equivalents may be resorted to, falling within the scope of the invention.

### BRIEF DESCRIPTION OF THE DRAWINGS

The accompanying drawings, which are incorporated herein and form a part of the specification, illustrate some but not the only or exclusive examples of the embodiments and/or steps of employment of the tabletop cooker with user engageable secondary cooking basket device and system herein. It is intended that the embodiments and figures disclosed herein are to be considered illustrative of current preferred modes of the device and the system rather than limiting.

FIG. 1 depicts a sectional view through the cooker assembly herein in a nesting or stored configuration showing the cooking basket having a secondary cooking area therein which is positioned within the primary cooking area defined by the sidewall of the cooker and bottom wall which is situated atop a heat source.

FIG. 1A depicts the cooker assembly herein in a stacked position ready for use with the cooking basket supported on an annular ring which sits atop the cooker.

FIG. 2 depicts a view of the annular ring in a position to be located atop an underlying cooker to support the basket above the cooker as in FIG. 4.

FIG. 3 shows a positioning of the annular ring atop the open end of the basket to allow the cooking basket to be located in the stored position nesting substantially within the primary cooking area of the cooker, as in FIG. 1.

FIG. 4 depicts the cooker assembly herein assembled to locate the cooking basket in a sealed engagement with the underlying annular ring upon which it sits thereby positioning the bottom of the cooking basket to receive heat and moisture from the primary cooking area heated by the cooker.

FIG. 5 is an overhead perspective view of one mode of the cooking basket showing the open end thereof surrounded by a circular ledge and openings in a bottom surface for passing heat and steam therethrough.

FIG. 6 shows the exterior of the cooking basket from the bottom side and shows the openings communicating through the bottom surface.

FIG. 7 shows a lower surface of the annular ring which contacts against the top of the cooker as in FIG. 4 in the stacked positioning to elevate the cooking basket and also in FIG. 1 to allow the device to reposition to the stowed positioning.

### DETAILED DESCRIPTION OF THE INVENTION

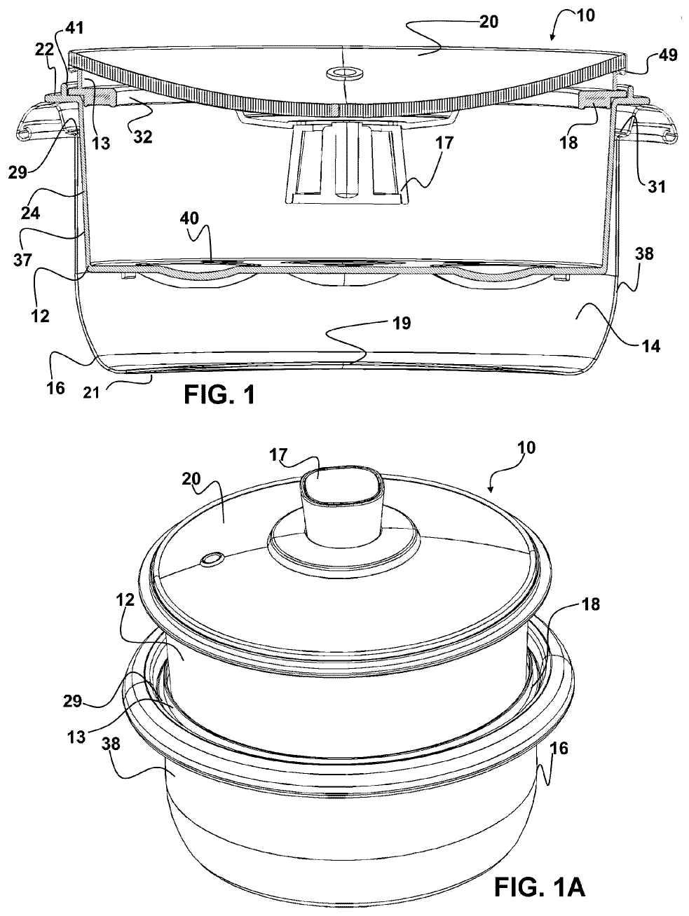

Referring now to the drawings in FIGS. 1-7, wherein similar parts of the cooker assembly invention are identified by like reference numerals, there is shown in FIG. 1 a sectional view through a center area of the cooker assembly device 10 where the formed cooker assembly is in the stowed or collapsed position where it is formed to the smallest and most compact configuration. In this stowed configuration, the cooking assembly has a cooking basket 12 which is positionable to be held substantially entirely within the primary cooking area 14 defined by the area between a cooker bottom wall 21 surrounded by a cooker sidewall 38 of the cooker 16 which extends to a cooker opening 29 (FIGS. 1 and 1A) such as with a rice cooker, slow cooker, or similar counter top cooker. A small cooker ledge 31 surrounds the cooker opening 29 and extends away from it.

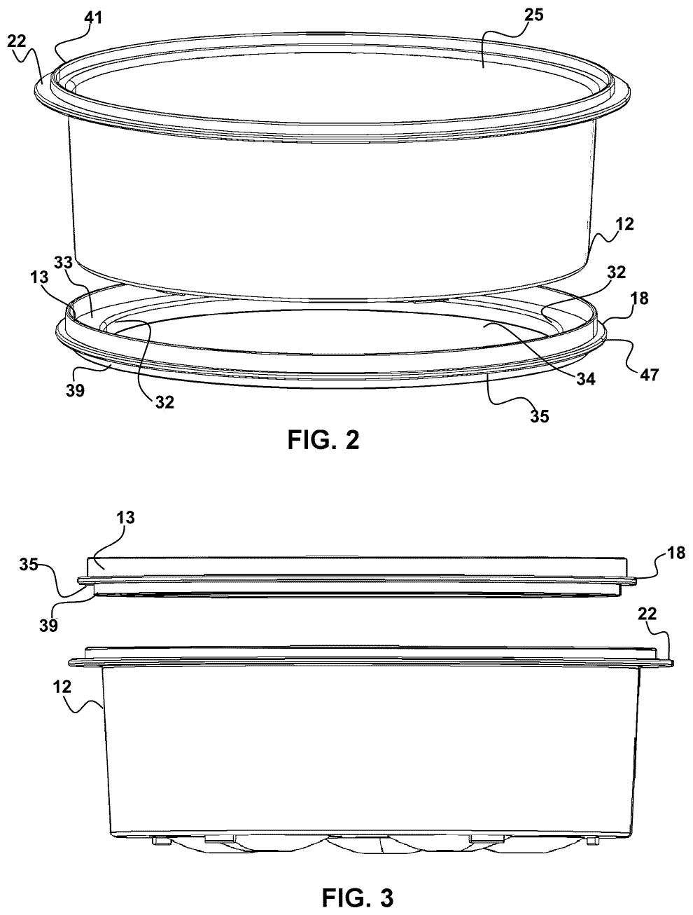

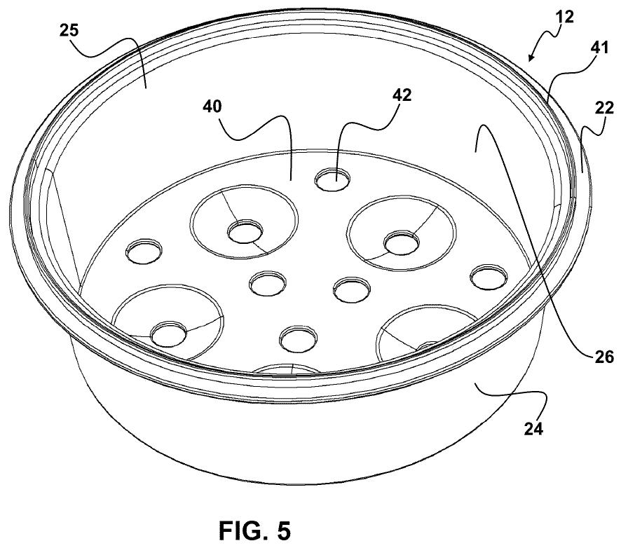

As shown in FIG. 1, the annular ring 18 is sandwiched between a surface of the lid 20 which contacts against the ring projection 13 and a cooking basket ledge 22. The ledge 22 extends away from the outside edge of the cooking basket sidewall 24 at the distal end thereof which surrounds the basket opening 25 (FIG. 5). The opening 25 provides access with the secondary cooking area 26 therein. The annular ring 18 and its positioning atop the cooking basket ledge 22 extending from the cooking basket sidewall 24 is shown enlarged in FIGS. 2-3.

The cooker assembly device 10 is shown in FIG. 1A in the stacked position or configuration. In this stacked configuration as noted herein it is ready for use with the cooking basket 12 supported on the annular ring 18 which sits atop the cooker 16. As can be seen, the lid 20 has been flipped from its position in FIG. 1, to now cover the basket opening 25 of the cooking basket 12.

Shown in FIG. 2 is the view of the annular ring 18 with the lower end of the cooking basket 12 in a position to contact a top surface 33 of the annular ring 18. A circumferential edge 32 defines a ring opening 34 communicating through the body of the annular ring 18. As also shown, a lower end of the cooking basket 12 will contact against the top surface 33 of the annular ring 18. The circumferential edge 32 defines a ring opening 34. A portion of the top surface 33 will extend around or under the lower end of the cooking basket 12 when it seats on the annular ring 18 with the assembly in the stacked position. A ring projection 13 may extend above this top surface 33 of the ring 18. The ring projection 13 will totally or partially surround the lower end of the cooking basket 12 when it is positioned upon the top surface 33 of the annular ring 18 to hold it from sliding.

The ring projection 13 also has a circumference which is sized to form a contact against a surface of a lid ring 49 positioned around the outside edge of the lid 20. This contact occurs when the basket 12 is in the stowed position of FIG. 1 and the lid 20 is inverted to place the handle 17 within the cooking area 26 of the basket 12. This contact forms a centering engagement of the lid 20 above the cooking basket 12. By centering engagement herein is meant that the lid 20 is held substantially centered above the cooking basket 12 with the device in the stowed position. This centering engagement also forms connection to hold the lid 20 form sliding while in the stowed position.

This seating of the cooking basket 12 on the annular ring 18 occurs by either the bottom surface of the cooking basket 12 contacting and sitting upon the top surface 33 of the annular ring or the seating may occur with the circumferential edge 32 surrounding the ring opening 34 contacting the lower end of the cooking basket sidewall 24 which has an inward taper 37 forming the diameter of the lower end of the cooking basket 12 such that it seats within the circumferential edge 32 and forms a sealed contact against the circumferential edge 32.

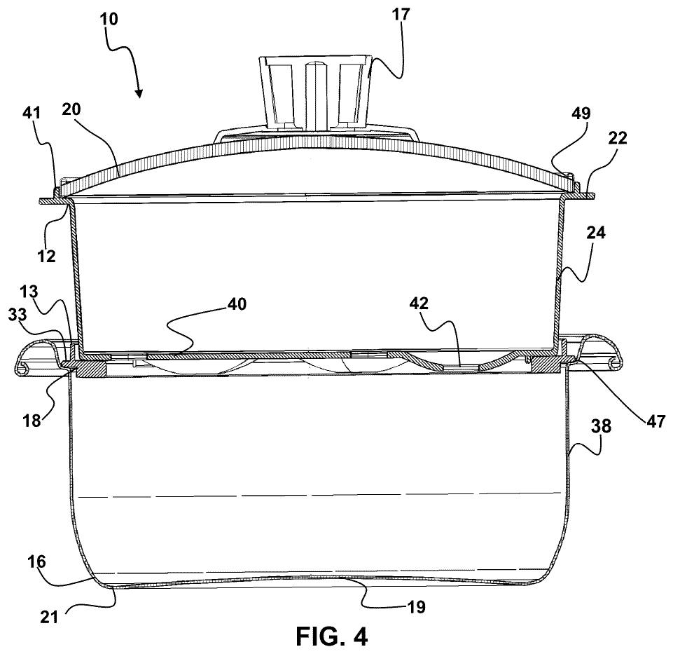

In either mode this contact of the cooking basket 12 with the annular ring 18 positions the assembly 10 in the stacked or deployed configuration of FIG. 1A or FIG. 4 when lower side 35 or surface of the annular ring 18 itself is seated upon the upper end of the cooker sidewall 38, such as depicted in FIGS. 1A and 4. An annular projection 39 extending from one or the lower side 35 of the annular ring 18 may project into the cooker opening 29 and contact the sidewall the interior of the cooker sidewall 38 to form and maintain a centered contact of the ring 18 atop the cooker opening 29 and it may form a second sealed engagement of the lower side of the ring 18 with the cooking area 14 of the cooker 16 such that heat and steam will rise into the secondary cooking area 26 within the cooking basket 12.

Shown in FIG. 4 and also in FIG. 1A, as noted, is a sectional view of the device 10 while in an assembled or stacked configuration substantially across the middle of FIG. 1A under for example the center of the handle 17. This stacked configuration locates the basket bottom wall 40 of the cooking basket 12 in a sealed engagement within the cooker opening 29 which is surrounded by the cooker ledge 31 extending away from the cooker opening 29 at the top of the cooker sidewall 38 thereby forming a sealed engagement with the cooking area 14. The ring projection 13 extending away from the top surface 33 of the ring 18 may be sized to surround the lower end of the cooking basket sidewall 24 where it intersects the cooking basket bottom wall 40 to hold the basket centered above the cooker 16 in a sealed engagement therewith.

As shown, the bottom of the cooking basket 12, so located and held in place by the annular ring 18, will receive heat and moisture communicated from the primary cooking area 14 heated by the cooker 16 which has a heat source such as an electric cooking element 19, which is well known in the art, although the system may also work with a natural gas heated cooker 16. For example only, the primary cooking area 14 in this configuration could be used to cook a first foodstuff such as rice, and the secondary cooking area 26 can concurrently be used for cooking a second foodstuff such as vegetables at same time.

Depicted in FIG. 5 is an overhead perspective view of one mode of the cooking basket 12 showing the open end defined by the basket opening 25 of the cooking basket 12. The opening at this distal end is surrounded by the circular basket ledge 22 located atop the distal end of the basket sidewall 24 and extending substantially normal therefrom.

A basket bottom wall 40 opposite the basket opening 25 on the opposite end of the basket sidewall 24 from a distal edge thereof defining the opening 25 into the basket. The cooking basket 12 may have at least one or a plurality of passages 42 formed through a bottom wall 40 thereof. The passages 42, while shown as circular and even-sized, may be any size and in any number appropriate for communicating heat and/or moisture from the primary cooking area 14 to secondary foodstuffs placed upon the basket bottom wall 40 and within the secondary cooking area 26. Recesses 23 may be placed to surround the openings 42. These recesses may be employed to cook eggs therein such as for hard-boiled eggs.

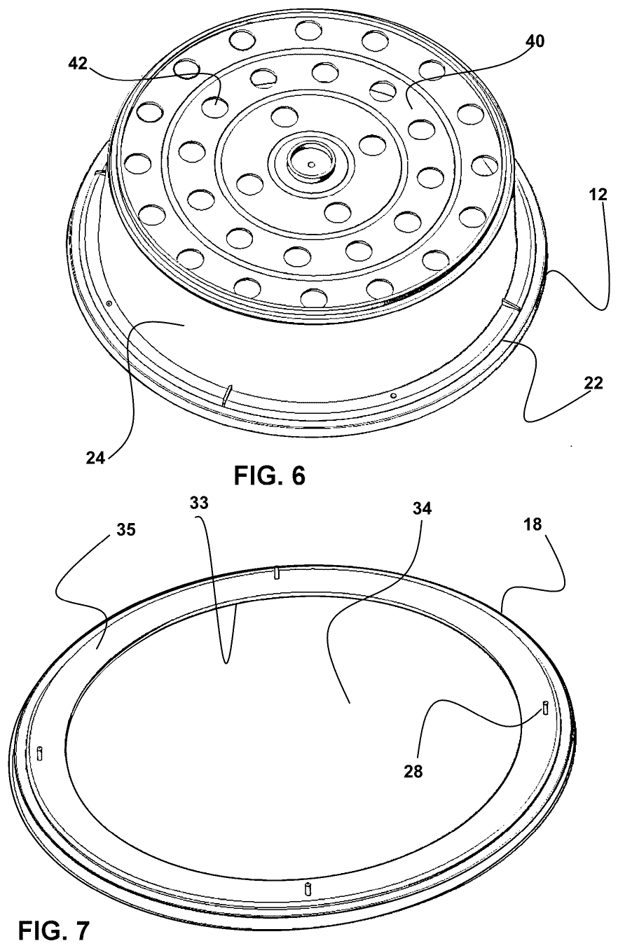

Shown in FIG. 6 is the exterior of the cooking basket 12 from the bottom side and shows the openings 42 communicating through the bottom surface 40. It is this bottom surface 40 which contacts against the annular ring 18 to position the device 10 in the stacked configuration noted. In FIG. 7 is depicted a lower surface of the annular ring 18 which contacts against the top of the cooker 16 as in FIG. 4 in the stacked positioning. The annular ring 18 is repositioned to the top surface or ledge running around the circumference of the basket access opening 25. A basket projection 41 projecting from the basket ledge 22 has a circumference which is sized to slide around the outside edge 47 of the annular ring 18 and hold it centered with the device 10 in the nesting or stored configuration of FIG. 1. As shown in FIG. 1 also, the basket projection 41 is sized to engage and hold the inside of the lid 20 in place while the device 10 is in this nesting or stored configuration

As noted above, while the present invention has been described herein with reference to particular embodiments thereof and steps in the method of employment of the modes thereof, a latitude of modifications, various changes and substitutions are intended in the foregoing disclosures, it will be appreciated that in some instance some features or steps in configuration and employment of the invention could be employed without a corresponding use of other features without departing from the scope of the invention as set forth in the following claims. All such changes, alterations and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A tabletop cooker apparatus, comprising:
a cooker assembly, said cooker assembly having a cooker having a first cooking area positioned between a cooker sidewall extending from a bottom wall at a bottom end of said cooker and an open end of said cooker located at an upper end of said cooker sidewall;
said bottom wall of said cooker having a heat source positioned thereon;
said cooker assembly having a cooking basket, said cooking basket having a secondary cooking area located within a basket sidewall extending from a basket bottom wall, said basket sidewall extending to a top edge thereof surrounding a basket opening;
a lid, said lid positionable upon said cooking basket to cover said basket opening;
at least one passage communicating through said basket bottom wall;
said cooker assembly having a stowed position wherein said basket sidewall of said cooker basket is recessed within said first cooking area; and
said cooker assembly having a stacked position wherein a lower end of said basket is in a sealed connection with said open end of said cooker, wherein heat communicated from said heat source to said first cooking area continues through said passage in said basket bottom wall and into said secondary cooking area, and a first foodstuff positioned in said first cooking area can be cooked concurrently with a second foodstuff positioned in said secondary cooking area.

2. The tabletop cooker apparatus of claim 1 additionally comprising:
an annular ring having a top surface extending to a circumferential interior edge thereof which surrounds and defines a ring opening communicating through said annular ring;
said annular ring having a bottom surface opposite a top surface thereof;
said bottom surface of said annular ring positioned atop said upper end of said cooker sidewall with said cooker assembly in said stacked position; and
said top surface of said annular ring forming a support for said lower end of said cooking basket positioned thereon with said cooker assembly in said stacked position.

3. The tabletop cooker apparatus of claim 2 additionally comprising:
a ring projection extending from said top surface of said ring; and
said ring projection surrounding a lower end of said basket sidewall with said cooker assembly in said stacked position.

4. The tabletop cooker apparatus of claim 3 additionally comprising:
said annular ring positionable to a sandwiched engagement between a top surface of said lid in a contact with said ring projection extending from said top surface of said annular ring and, a basket ledge extending from said upper edge of said cooking basket sidewall in contact with said bottom surface of said annular ring, with said cooker assembly in said stowed position.

5. The tabletop cooker apparatus of claim 4 additionally comprising:
said top surface of said lid having a handle extending therefrom; and
said handle being recessed within said secondary cooking area with said cooker assembly in said stowed position.

6. The tabletop cooker apparatus of claim 4 additionally comprising:
a basket projection extending from said basket ledge;
a lid ring extending from said top surface of said lid;
said lid ring surrounding said ring projection with said cooker assembly in said stowed position; and
said lid ring forming a centering engagement with said basket projection for maintaining said lid centered above said cooking basket.

7. The tabletop cooker apparatus of claim 2 additionally comprising:
a cooker ledge extending from said upper end of said cooker sidewall; and
said bottom surface of said annular ring positioned atop said cooker ledge with said cooker assembly in said stacked position.
